(19) United States
(12) Patent Application Publication
(10) Pub. No.: US 2015/0281377 A1
(43) Pub. Date: Oct. 1, 2015

(54) METHOD, DEVICE AND SYSTEM FOR EVENT REMINDING

(71) Applicant: Xiaomi Inc., Beijing (CN)

(72) Inventors: Dongjie Qi, Beijing (CN); Mingxue Kangshang, Beijing (CN); Fang Wang, Beijing (CN)

(21) Appl. No.: 14/528,832

(22) Filed: Oct. 30, 2014

Related U.S. Application Data
(63) Continuation of application No. PCT/CN2014/082886, filed on Jul. 24, 2014.

(30) Foreign Application Priority Data
Mar. 27, 2014 (CN) 201410119630.0

(51) Int. Cl. H04L 29/08; H04L 29/06

(52) U.S. Cl. CPC H04L 67/16; H04L 67/42

(57) ABSTRACT

The present disclosure discloses a method, a device, and a system for event reminding. The method includes: acquiring a reminder event in an alarm channel, the alarm channel providing an event reminder service to a plurality of clients at the same time; acquiring a subscription list of the alarm channel, the subscription list comprising the clients subscribing to the alarm channel; and sending the reminder event to the clients on the subscription list, the reminder event instructing each of the clients to issue an event reminder according to the reminder event.

### CROSS REFERENCE TO RELATED APPLICATIONS

This application is a continuation of International Application No. PCT/CN2014/082886, filed Jul. 24, 2014, which claims priority from Chinese Patent Application No. 201410119630.0, filed Mar. 27, 2014, the entire contents of all of which are incorporated herein by reference.

### TECHNICAL FIELD

The present disclosure relates to the field of Internet and, more particularly, to a method, a device and a system for event reminding.

### BACKGROUND

With the pace of life continuing to increase, people in general need to deal with more and more tasks each day. Thus, an alarm with reminder functions is becoming one of the most important functions in a terminal, such as a smart mobile phone, a table PC, a smart television, an eBook reader, a Moving Picture Experts Group Audio Layer III (MP3) player, a Moving Picture Experts Group Audio Layer IV (MP4) player, a portable computer, a desktop computer, and the like.

In practical applications, a user can remind himself to timely deal with certain things by setting an alarm. For example, if the user shall have a meeting at three in the afternoon, the user can set the alarm for 2:40 p.m. to remind himself to participate the meeting on time; and if the user needs to go to work as usual, he can set a wake up alarm in the morning to remind himself to get up in time.

However, when the user encounters special circumstances, for example, when the company requires the user to go to work an hour earlier than usual, the wake up alarm set by the user in the past will not be applicable. Under such circumstances, in order to go to work in time, the user needs to change his alarm setting. If the user forgets to change it, the user will not receive a timely alarm or reminder. As a result, the user would delay handling a certain tasks, or even forget about them.

### SUMMARY

According to a first aspect of the present disclosure, there is provided a method for event reminding, comprising: acquiring a reminder event in an alarm channel, the alarm channel providing an event reminder service to a plurality of clients at the same time; acquiring a subscription list of the alarm channel, the subscription list comprising the clients subscribing to the alarm channel; and sending the reminder event to the clients on the subscription list, the reminder event instructing each of the clients to issue an event reminder according to the reminder event.

According to a second aspect of the present disclosure, there is provided a method for event reminding, comprising: creating a reminder event in an alarm channel, the alarm channel providing an event reminder service to a plurality of clients at the same time; and sending the reminder event to an alarm server, the reminder event instructing the alarm server to forward the reminder event to the clients on a subscription list of the alarm channel, the subscription list comprising the clients subscribing to the alarm channel, and the reminder event instructing each of the clients to issue an event reminder according to the reminder event.

According to a third aspect of the present disclosure, there is provided a method for event reminding, comprising: receiving a reminder event from an alarm server, the reminder event being acquired from an alarm channel by the alarm server, and being sent to each of a plurality of clients on a subscription list of the alarm channel after acquiring the subscription list, the alarm channel providing an event reminder service to the clients at the same time, and the subscription list comprising the clients subscribing to the alarm channel; and issuing an event reminder according to the reminder event.

According to a fourth aspect of the present disclosure, there is provided a terminal for event reminding, the terminal comprising: a processor; and a memory for instructions executable by the processor; wherein the processor is configured to: receive a reminder event from an alarm server, the reminder event being acquired from an alarm channel by the alarm server, and being sent to each of a plurality of clients on a subscription list of the alarm channel after acquiring the subscription list, the alarm channel providing an event reminder service to the clients at the same time, and the subscription list comprising the clients subscribing to the alarm channel; and issue an event reminder according to the reminder event.

It is to be understood that both the foregoing general description and the following detailed description are exemplary only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the present disclosure.

FIG. 1 is a block diagram of a system for event reminding, according to an exemplary embodiment.

FIG. 2 is a flowchart of a method for event reminding, according to an exemplary embodiment.

FIG. 3 is a flowchart of a method for event reminding, according to an exemplary embodiment.

FIG. 4 is a flowchart of a method for event reminding, according to an exemplary embodiment.

FIG. 5 is a flowchart of a method for event reminding, according to an exemplary embodiment.

FIG. 6A is a flowchart of a method for event reminding, according to an exemplary embodiment.

FIG. 6B is a schematic diagram of a display, according to an exemplary embodiment.

FIG. 6C is a schematic diagram of a display, according to an exemplary embodiment.

FIG. 6D is a flowchart of a method for event reminding, according to an exemplary embodiment.

FIG. 6E is a schematic diagram of a display, according to an exemplary embodiment.

FIG. 6F is a flow chart of a method for event reminding, according an exemplary embodiment.

FIG. 6G is a schematic diagram of a display, according to an exemplary embodiment.

FIG. 7 is a block diagram of a device for event reminding, according to an exemplary embodiment.

FIG. 8 is a block diagram of a device for event reminding, according to an exemplary embodiment.

FIG. 9 is a block diagram of a device for event reminding, according to an exemplary embodiment.

FIG. 10 is a block diagram of a device for event reminding, according to an exemplary embodiment.

FIG. 11 is a block diagram of a device for event reminding, according to an exemplary embodiment.

FIG. 12 is a block diagram of a device for event reminding, according to an exemplary embodiment.

FIG. 13 is a block diagram of a server, according to an exemplary embodiment.

FIG. 14 is a block diagram of an apparatus for event reminder, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

The term “terminal” used in this disclosure means general electronic equipment. A terminal may be, for example, a smart mobile phone, a table PC, a smart television, an eBook reader, a Moving Picture Experts Group Audio Layer III (MP3) player, a Moving Picture Experts Group Audio Layer IV (MP4) player, a portable computer, a desktop computer, and the like.

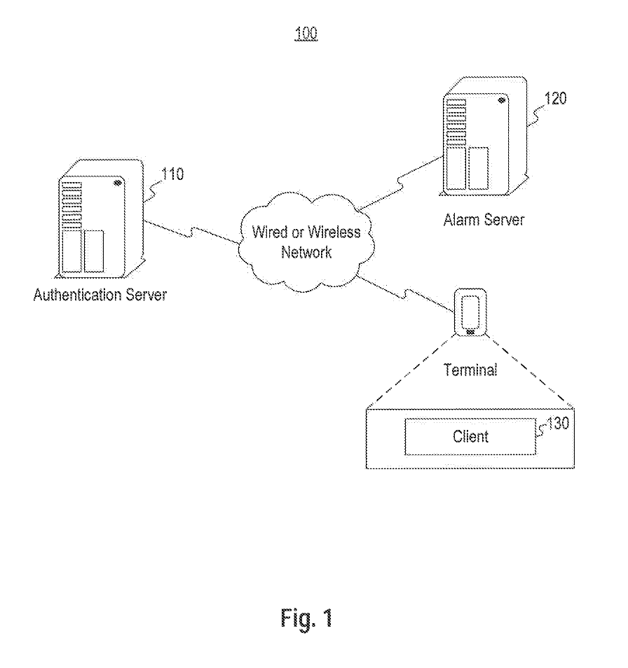

FIG. 1 is a block diagram or a system 100 for event reminding, according to an exemplary embodiment. For example, the system 100 is configured to perform the event reminding methods described below. Referring to FIG. 1, the system 100 may include an authentication server 110, an alarm server 120, and a client 130.

The authentication server 110 may be connected to the alarm server 120 via a wired or wireless network, and then request the alarm server 120 to create an alarm channel, and send a reminder event in the alarm channel to the alarm server 120. Additionally, the authentication server 110 may also authenticate each client subscribing to the alarm channel.

The alarm server 120 is connected to both the authentication server 110 and the client 130 via a wired or wireless network. The alarm server 120 may create an alarm channel according to the a request of the authentication server 110, and send the reminder event in the alarm channel to each of the client 130 subscribing to the alarm channel.

The client 130 operates in the terminal, and is provided by a provider of the alarm service. Additionally, the client 130 may receive the reminder event in the subscribed alarm channel which is sent from the alarm server 120.

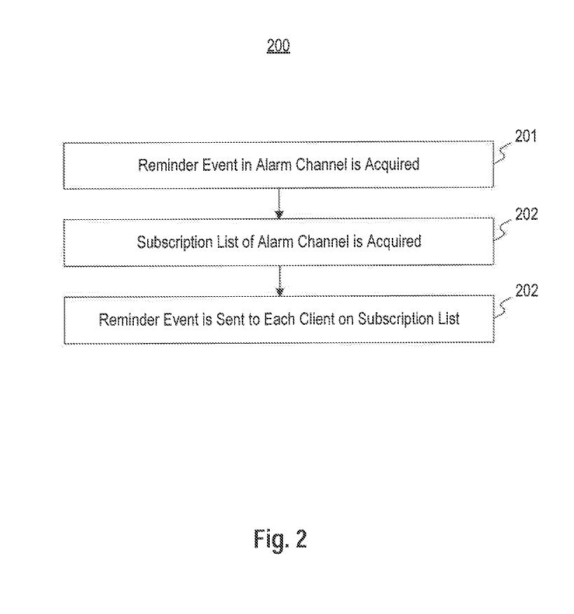

FIG. 2 is a flowchart of a method 200 for event reminding, according to an exemplary embodiment. Referring to FIG. 2, the method 200 for event reminding is utilized in the alarm server 120 in the system 100 (FIG. 1), and the method 200 for event reminding may include the following steps.

In step 201, a reminder event in an alarm channel is acquired. The alarm channel provides an event reminder service to a plurality of clients at the same time. In step 202, a subscription list of the alarm channel is acquired. The subscription list includes each of the clients subscribing to the alarm channel. In step 203, the reminder event is sent to each client on the subscription list. The reminder event instructs each of the clients to issue an event reminder according to the reminder event.

In summary, according to the above exemplary embodiment, the method 200 includes: acquiring a reminder event in an alarm channel, the alarm channel providing an event reminder service to a plurality of clients at the same time; acquiring a subscription list of the alarm channel, the subscription list including the clients subscribing to the alarm channel; and sending the reminder event to each of the clients on the subscription list, the reminder event instructing each of the clients to issue an event reminder according to the reminder event without requiring a user to set a reminder in his terminal. The method 200 for event reminding, according to the above exemplary embodiment solves the problems in the related art that requires a user to set an alarm for individual events. It also avoids the problem of a user forgetting to set an alarm and missing the important events. Additionally, the method 200 solves the problem of having an event notification issued too late for a user to set an event reminder. Accordingly, a user does not need to manually set an alarm, and can receive the alarm reminder timely. Thus, the user avoids delaying or forgetting an event.

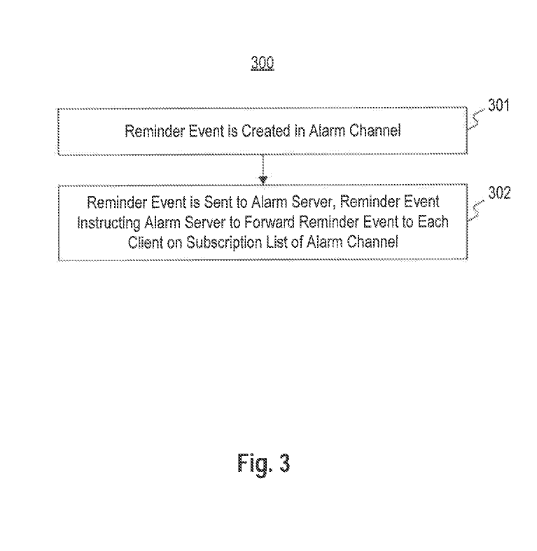

FIG. 3 is a flowchart of a method 300 for event reminding, according to an exemplary embodiment. Referring to FIG. 3, the method 300 for event reminding is utilized in the authentication server 110 of the system 100 (FIG. 1), and the method 300 for event reminding may include the following steps. In step 301, a reminder event is created in an alarm channel. The alarm channel provides an event reminder service to a plurality of clients at the same time. In step 302, the reminder event is sent to an alarm server, and the reminder event instructs the alarm server to forward the reminder event to each of the clients on a subscription list of the alarm channel. The subscription list includes each of the clients subscribing to the alarm channel, and the reminder event instructs each of the clients to issue an event reminder according to the reminder event.

In summary, according to the above exemplary embodiment, the method 300 includes: creating a reminder event in an alarm channel, the alarm channel providing an event reminder service to a plurality of clients at the same time; and sending the reminder event to an alarm server, the reminder event instructing the alarm server to forward the reminder event to each of the clients on the subscription list of the alarm channel, the subscription list including each of the clients subscribing to the alarm channel, and the reminder event instructing each of the clients to issue an event reminder according to the reminder event. The method 300 for event reminding, according to the above exemplary embodiment solves the problems in the related art that requires a user to set an alarm for individual events. It also avoids the problem of a user forgetting to set an alarm and missing the important events. Additionally, the method 300 solves the problem of having an event notification issued too late for a user to set an event reminder. Accordingly, a user does not need to manually set an alarm, and can receive the alarm reminder timely. Thus, the user avoids delaying or forgetting an event.

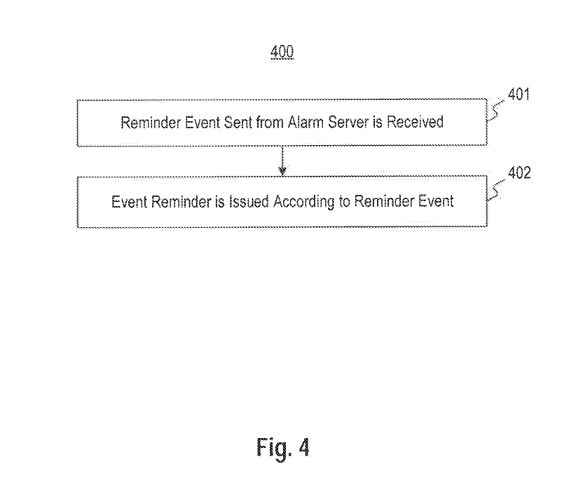

FIG. 4 is a flowchart of a method 400 for event reminding according to an exemplary embodiment. Referring to FIG. 4, the method 400 for event reminding is utilized in the client 130 of the system 100 (FIG. 1), and the method 400 for event reminding may include the following steps. In step 401, a reminder event sent from an alarm server is received. The reminder event is in an alarm channel, and is sent to each of the clients on a subscription list of the alarm channel after the subscription list is acquired. The alarm channel provides an event reminder service to a plurality of clients at the same time, and the subscription list includes each of the clients subscribing to the alarm channel. In step 402, an event reminder is issued according to the reminder event.

In summary, according to the above exemplary embodiment, the method 400 includes: receiving a reminder event from an alarm server, the reminder event being in an alarm channel, acquired by the alarm server, and sent to each of the clients in a subscription list of the alarm channel after acquiring the subscription list, the alarm channel providing an event reminder service to a plurality of clients at the same time, and the subscription list including each of the clients subscribing to the alarm channel; and issuing an event reminder according to the reminder event. The method 400 for event reminding, according to the above exemplary embodiment solves the problems in the related art that requires a user to set an alarm for individual events. It also avoids the problem of a user forgetting to set an alarm and missing the important events, Additionally; the method 400 solves the problem of having an event notification issued too late for a user to set an event reminder. Accordingly, a user does not need to manually set an alarm, and can receive the alarm reminder timely. Thus, the user avoids delaying or forgetting an event.

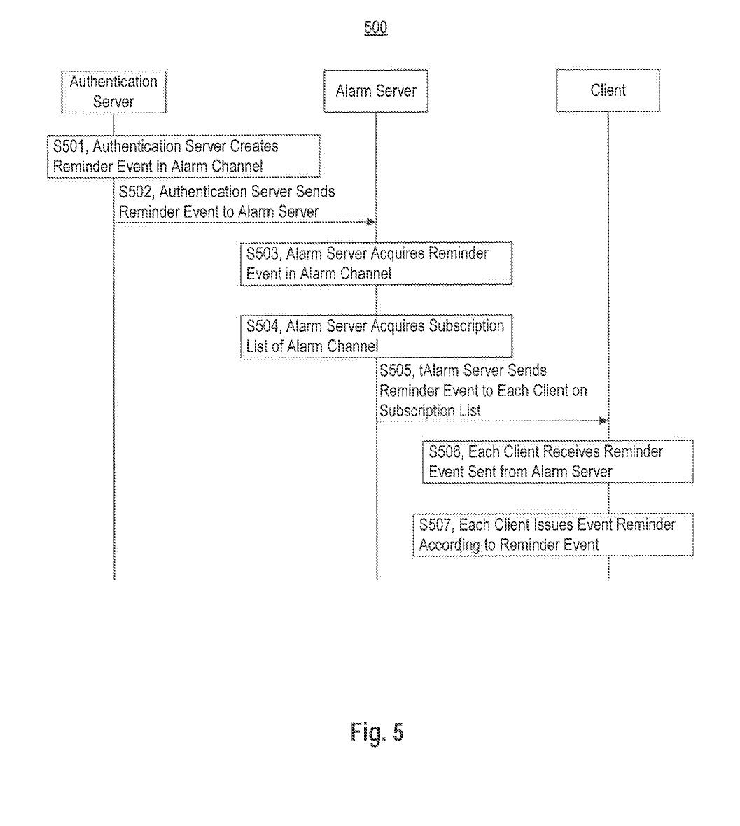

FIG. 5 is a flowchart of a method 500 for event reminding, according to an exemplary embodiment. Referring FIG. 5, the method 500 for event reminding can be utilized in the system 100 (FIG. 1), and the method 500 for event reminding may include the following steps.

In step 501, an authentication server creates a reminder event in an alarm channel. The authentication server may create a reminder event in its own alarm channel. The reminder event includes, e.g., a reminder time and a reminder reason, and the alarm channel provides an event reminder service to a plurality of clients at the same time. For example, if a company's normal work hour is 10:00 a.m., in a special occasion, the company may require employees to start working at 8:30 a.m. on March 18^{th}. In order to remind the employees to be on time for work, a company administrator may create in the alarm channel of the company a reminder event of starting to work at 8:30 a.m. on March 18^{th}.

In step 502, the authentication server sends the reminder event to an alarm server. The reminder event instructs the alarm server to forward the reminder event to each of the clients on a subscription list of the alarm channel, wherein the subscription list includes each of the clients subscribes to the alarm channel.

In step 503, the alarm server acquires the reminder event in the alarm channel.

In step 504, the alarm server acquires a subscription list of the alarm channel. After the alarm server acquires the reminder event in the alarm channel in step 503, the alarm server may acquire the subscription list of the alarm channel. Additionally, the alarm server may acquire the subscription list according to a channel ID of the alarm channel in the reminder event. For example, the alarm channel is a certain company's alarm channel, and, according to a channel ID of the alarm channel, the alarm server may acquire a member list including all members of the company who subscribe to the alarm channel.

In step 505, the alarm server sends the reminder event to each of the clients on the subscription list. After the alarm server acquires the subscription list, in order to inform each client on the subscription list that there is a new reminder event, the alarm server may send the reminder event to each client on the subscription list. The reminder event instructs each client to issue an event reminder according to the reminder event.

In step 506, each of the clients receives the reminder event sent from the alarm server. Accordingly, each of the clients subscribing to the alarm channel may receive the reminder event sent from the alarm server.

In step 507, each client issues an event reminder according to the reminder event. After receiving the reminder event, the client may issue the event reminder according to the reminder event. For example, when the reminder time in the reminder event arrives, the client issues a reminder in a form of an alarm or a vibration. Additionally, the client may change the reminder time in the reminder event according to a user's needs. For example, if the client used by employees of the company receives a reminder event of starting work at 8:30 a.m. on March 18^{th}, in order to arrive the company at 8:30 a.m., the user may change the reminder time of the reminder event to 7:30 a.m., such that the alarm in the client will remind the user to get up early at 7:30 a.m. to go to work by 8:30 a.m. on March 18^{th}.

Further, the client may not change the reminder time in the reminder event. For example, if a certain producer wants to improve an audience rating of a new show on a video website, the producer may send a reminder event to the users via an alarm channel of the video website to remind the users to watch the show. Each client subscribing to the alarm channel of the video website may receive a reminder event regarding the show at 8:00 p.m. Thus, at 8:00 p.m. each day, the reminder event indicating that the show has been updated is provided to the client. This avoids the problem of not being able to watch the latest episode as soon as the show is updated.

In a first implementation of the above exemplary embodiment of the method 500, the company administrator may create a reminder event in the company's alarm channel. A alarm server sends the reminder event to employees of the company for reminding the employees to handle a certain tasks on time. For example, if a company administrator creates a reminder event of gathering at a gate of the company at 9:00 a.m. on March 22^{nd} for a spring outing, the employees of the company may receive the reminder event from the alarm server, and then arrive at the gathering location on time.

In a second implementation of the above exemplary embodiment of the method 500, in order to improve the audience rating of a show on a video website, the producer of the show issues a reminder to the clients regarding a new episode of the show via the alarm channel for reminding the users to watch the new episode of the show. For example, a reminder event is created that two new episodes of the show will be available at 8:00 p.m. daily. The alarm server sends the reminder event to each client, and, with the reminder of the reminder event, each client may watch the latest episodes on time. This avoids a problem of inaccurate audience rating caused by missing the new episodes because the viewers do not know the availability of the new episodes. By sending the reminder event to each client, the above problem is avoided and user experiences is improved.

In a third implementation of the above exemplary embodiment of the method 500, in order to help tourists to conveniently buy tickets during holidays, a railway company may create a reminder event of ticket release. For example, the railway company creates a reminder event of ticket release at 3:00 p.m. daily. The customers may accordingly receive the reminder event sent from an alarm server, and access the railway company's website to purchase the tickets at the ticket release time. Additionally, in order to prevent the railway company website from overcrowding due to large number of users simultaneously accessing the website at the ticket release time, after receiving the reminder event, the client may move up the reminder time of the reminder event, such that users may access the official website in advance.

In a fourth implementation of the above exemplary embodiment of the method 500, a shopping website may create a reminder event in the alarm channel and send the reminder event to each client via the alarm server. For example, if the shopping website launches a home appliance sales event at noon on March 20^{th}, an administrator of the shopping website may create a reminder event of a home appliance sales event of at noon on March 20^{th}, and send the reminder event to each client by the alarm server. This would avoid the problem of consumers missing the sales event, it should be noted that method 500 is not limited to the above implementations.

In summary, according to the above exemplary embodiment, the method 500 includes: acquiring a reminder event in an alarm channel, the alarm channel providing an event reminder service to a plurality of clients at the same time; acquiring a subscription list of the alarm channel, the subscription list including each of the clients subscribing to the alarm channel; and sending the reminder event to each of the clients on the subscription list, the reminder event instructs each of the clients to issue an event reminder according to the reminder event without requiring a user to set a reminder in his terminal. The method 500 for event reminding solves the problems in the related art that requires a user to set an alarm for individual events. It also avoids the problem of a user forgetting to set an alarm and missing the important events. Additionally, the method 500 solves the problem of having an event notification issued too late for a user to set an event reminder. Accordingly, a user does not need to manually set an alarm, and can receive the alarm reminder timely. Thus, the user avoids delaying or forgetting an event.

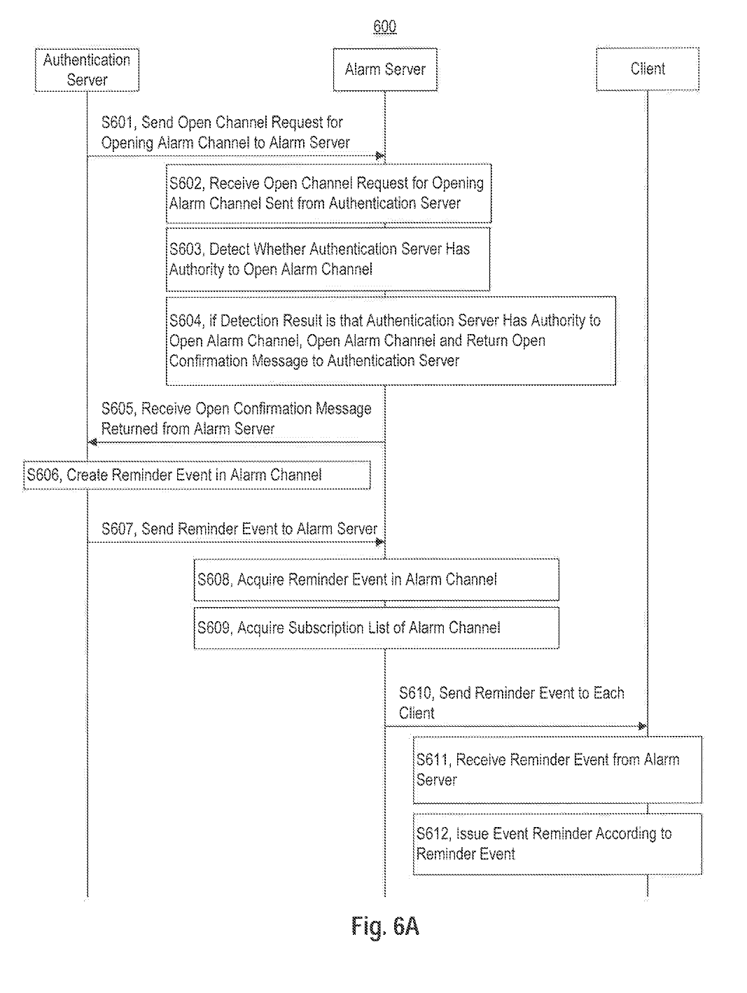

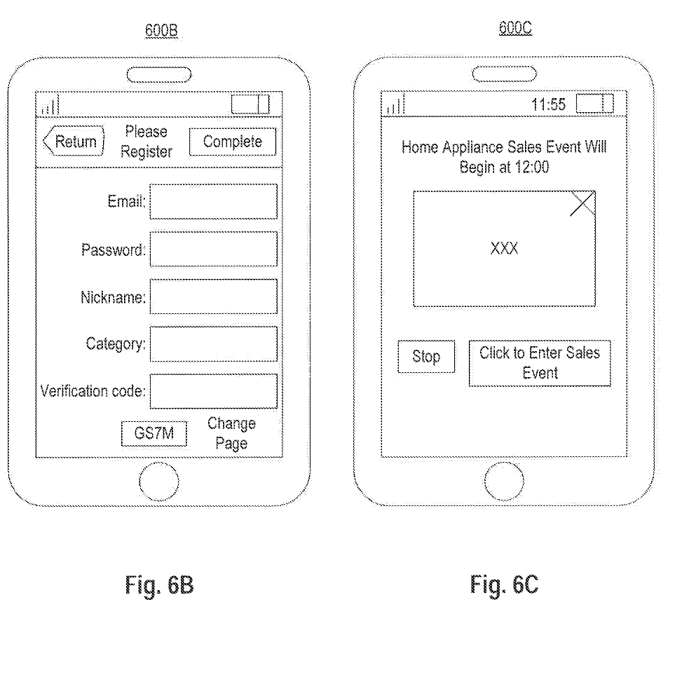

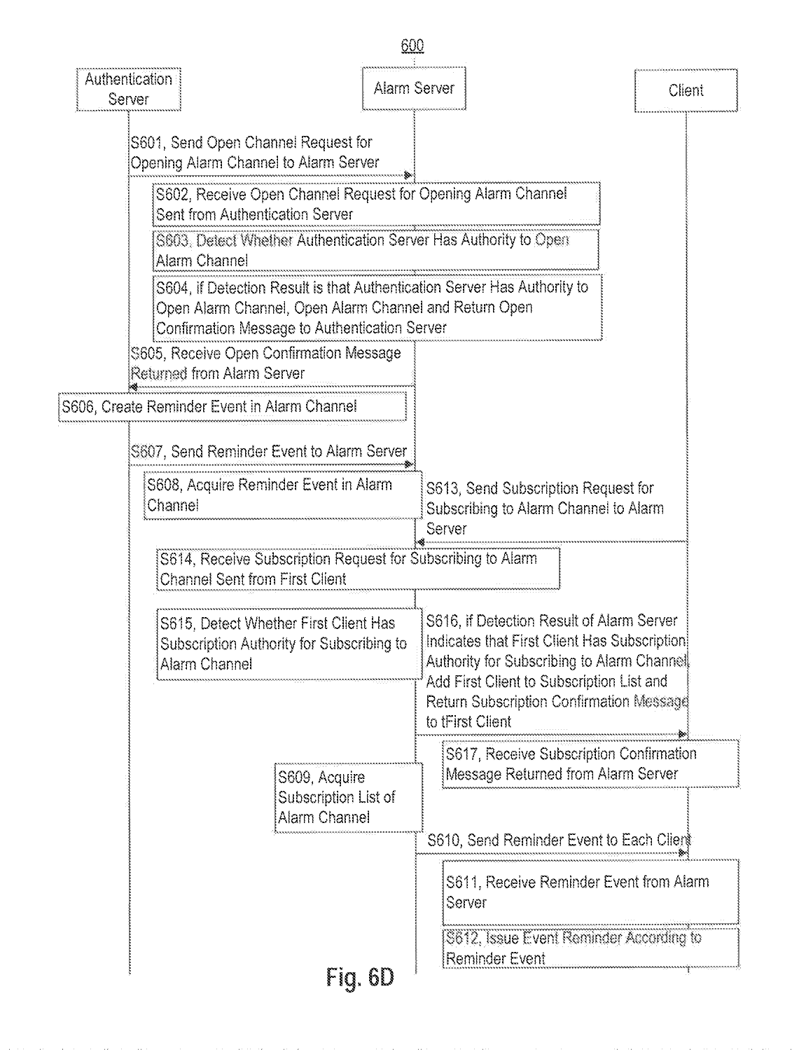

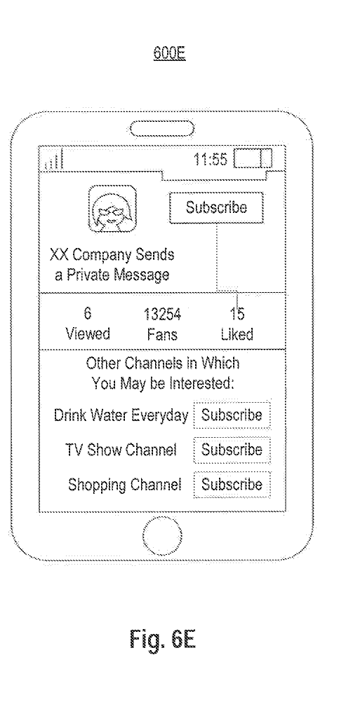

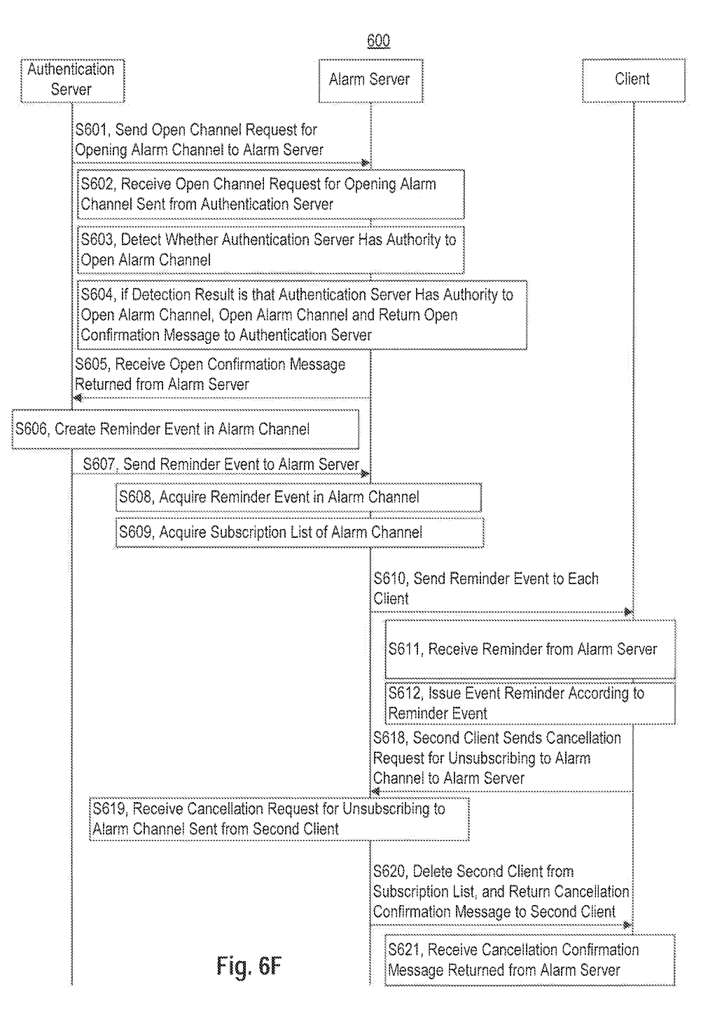

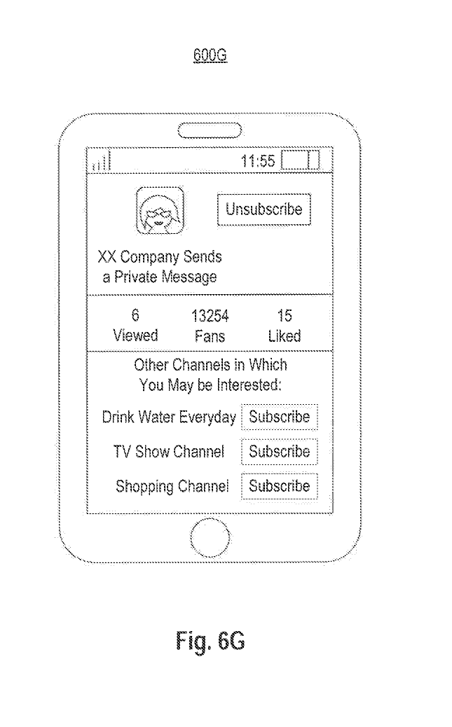

FIG. 6A is a flowchart of a method 600 for event reminding, according an exemplary embodiment. Referring to FIG. 6A, the method 600 for event reminding can be applied in the system 100 (FIG. 1), and the method 600 for event reminding may include the following steps.

In step 601, an authentication server sends to an alarm server an open channel request for opening an alarm channel. When the authentication server needs to utilize the alarm service provided by the alarm server, the authentication server may send to the alarm server an open channel request for opening the alarm channel. The alarm channel provides an event reminder service to a plurality of clients at the same time. Additionally, the authentication server may access a request interface for opening the alarm channel provided by, the alarm server, and fill in relevant information in the request interface. Following a submission of the relevant information, the authentication server sends the open channel request to the alarm server. For example, the authentication server accesses a request interface 600B in FIG. 6B. Following a submission of relevant information in the request interface, the authentication server sends the open channel request for opening the alarm channel to the alarm server.

In step 602, the alarm server receives the open channel request for opening the alarm channel sent from the authentication server. In step 603, the alarm server detects whether the authentication server has an authority to open the alarm channel. For example, the alarm server may verify the received relevant information at the request interface submitted by the authentication server. If the received relevant information is approved, the alarm server determines that the authentication server has an authority to open the alarm channel, if the alarm server is not approved, the alarm server determines that the authentication server has no authority to open the alarm channel. The step of verifying data by the alarm server may include: detecting whether the email address and password entered in the request interface match. If they match, then the authentication server has an authority to open an alarm channel. If they do not match, then the authentication server does not have an authority to open an alarm channel. Additionally, the alarm server may also detect whether the classification of the alarm channel requested for opening is legal. The method 600, according to the above exemplary embodiment is not limited to the above examples.

It should be noted that the above examples are for illustration purposes, and that other methods of requesting an opening of the alarm channel may be used. For example, the exemplary embodiment does not limit the data contents required for requesting an opening of the alarm channel. With different data contents, the methods for an alarm server to detect whether the authentication server has an authority to open the alarm channel are different. The present embodiment is not limited to the above examples.

In step 604, if the detection result of the alarm server indicates that the authentication server has an authority to open the alarm channel, the alarm server opens the alarm channel, and an open confirmation message indicating a successful opening of the alarm channel is returned to the authentication server. Additionally, the alarm server may assign a channel ID to the alarm channel for identifying the alarm channel. If the detection result of the alarm server indicates that the authentication server does not have authority to open the alarm channel, the process is terminated.

In step 605, the authentication server receives from the alarm server an open confirmation message indicating that the alarm channel is successfully opened. The open confirmation message indicates that the authentication server has the authority to open the alarm channel and has opened the alarm channel following the alarm server's reception of the open channel request, and alarm server's detection of the authentication server's authority to open the alarm channel.

In step 606, the authentication server creates a reminder event in the alarm channel. When the authentication server receives the open confirmation message indicating that the alarm channel is successfully opened, the authentication server may create a reminder event in the alarm channel. The reminder event includes, e.g., a reminder time and a reminder reason.

Additionally, the method of creating a reminder event by the authentication server may include: creating a reminder event that includes a reminder time, a reminder reason, and a reminder manner in the alarm channel. The reminder manner includes at least one of a reminder number, a reminder ringtone, and a reminder page. Also, the reminder ringtone may be a default ringtone set in the alarm server, or a personalized ringtone corresponding to the reminder event. For example, when the shopping website creates a reminder event, the reminder ringtone in the created reminder event may be an advertising video of the website. The reminder page may be an operating portal for guiding respective clients to respond to the reminder event. For example, when the shopping website creates a reminder event, the created reminder page may include a portal for entering the sales event. When a video website creates a reminder event, the created reminder page may be a portal for viewing videos.

Further, the reminder manner, for example, may include the reminder number, the remind ringtone, and the reminder page. When an administrator of a shopping website creates a reminder event for reminding a sales event by using the authentication server, the authentication server may generate a reminder event that includes a reminder time of 12:00 at noon on March, 20^{th}, a reminder reason of home appliance sales event, a reminder number of three times, the reminder ringtone of an advertising video of the shopping website, and a reminder page being a portal to the sales event.

In step 607, the authentication server sends the reminder event to the alarm server. After creating the reminder event, the authentication server may send the reminder event to the alarm server. The reminder event instructs the alarm server to forward the reminder event to each client on the subscription list of the alarm channel.

In step 608, the alarm server acquires the reminder event in the alarm channel,

In step 609, the alarm server acquires a subscription list of the alarm channel. After acquiring the reminder event in the alarm channel, the alarm server may acquire the subscription list of the alarm channel. The subscription list includes clients subscribing to the alarm channel. Additionally, the alarm server may acquire the subscription list of the alarm channel according to the channel ID of the alarm channel.

In step 610, the alarm server sends to each client the reminder event including a reminder time and a reminder reason. After acquiring the subscription list of the alarm channel, the alarm server may send each of the clients the reminder event including a reminder time, and a reminder reason. The reminder event instructs each of the clients to issue the event reminder according to the reminder event. Additionally, the method of sending to each of the clients the reminder event by the alarm server may include the following steps.

First, for each client, the alarm server detects whether a condition of a network in communication with the client is better than a preset condition. For each client, the alarm server may detect whether a condition of a network in communication with the client is better than the preset condition. For example, if the preset condition is a 2G (2-Generation wireless telephone technology) network, the alarm server will detect whether a condition of a network in communication with the client is better than the 2G network.

Second, if the condition of network in communication with the client is better than the preset condition, the reminder event, including the reminder time, the reminder reason, and the reminder manner, is sent to the client. The reminder manner includes at least one of a reminder number, a reminder ringtone, and a reminder page. If the detection result indicates that the condition of the network in communication with the client is better than the preset condition, then the alarm server may send the reminder event, including the reminder time, the reminder reason, and the reminder manner to the client. For example, if the alarm server detects that the alarm server communicates with the client via 3G network, which is faster than the present condition being a 2G network, the server may send the reminder event including the reminder time, the reminder reason, and the reminder manner to the client.

On the other hand, if the detection result indicates that the condition of the network in communication with the client is inferior than the preset condition, then the alarm server may send to the client the reminder event including, e.g., only the reminder time and the reminder reason.

In step 611, each client receives from the alarm server the reminder event including the reminder time and the reminder reason. Accordingly, each client subscribing to the alarm channel may receive the reminder event send by the alarm server.

In step 612, each client issues an event reminder according to the reminder event. The client may issue the event reminder according to the reminder event. For example, when a reminder time in the reminder event arrives, the client issues a reminder in form of an alarm or a vibration.

Additionally, after receiving the reminder event, the client may select to change the reminder time in the reminder event according to user's needs. For example, when the client receives a reminder event of an online home appliance sales event at noon, in order to improve the user's success rate of purchasing his desired appliance, the user may want to enter the sales event page in advance. For that purpose, the user may move up the reminder time in the reminder event five minutes early to 11:55 a.m., as illustrated in FIG. 6C. When the reminder number is more than one, the client will issue the reminder according to the reminder number separated by a predetermined time period.

In summary, according to the above exemplary embodiment, the method 600 includes: acquiring a reminder event in an alarm channel, the alarm channel providing an event reminder service to a plurality of clients at the same time; acquiring a subscription list of the alarm channel, the subscription list including clients subscribing to the alarm channel, and then sending the reminder event to each client on the subscription list, the reminder event instructing each client to issue an event reminder without requiring an user to set a reminder in his terminal. The method 600 for event reminding solves the problems in the related art that requires a user to set an alarm for individual events. It also avoids the problem of a user forgetting to set an alarm and missing the important events. Additionally, the method 600 solves the problem of having an event notification issued too late for a user to set an event reminder. Accordingly, a user does not need to manually set an alarm, and can receive the alarm reminder timely. Thus, the user avoids delaying or forgetting an event.

Additionally, the reminder event may also include at least one of a reminder number, a reminder ringtone, and a reminder page, such that the authentication server may emphasize the reminder event by including the reminder ringtone while sending the reminder to the client, and may also emphasize the reminder event by including a portal in the reminder page for guiding the user's response to improve the user experience.

Further, after a successful creation of the alarm channel by the authentication server, the client may request to subscribe to the alarm channel. Referring to FIG. 6D, the method 600 for event reminding may further include the following steps.

in step 613, a first client sends to the alarm server a subscription request for subscribing to the alarm channel. After the alarm server creates the alarm channel, the user may request to subscribe the alarm channel, i.e., the user uses the first client to send a subscription request for subscribing to the alarm channel. In step 614, the alarm server receives the subscription request for subscribing to the alarm channel sent from the first client. Accordingly, the alarm server may receive the subscription request for subscribing to the alarm channel sent from the first client. For example, with reference to FIG. 6E, in an interface 600E of an alarm channel displayed by the first client, the user may click on a subscribe button, and then the first client sends the subscription request for subscribing to the alarm channel after receiving the click signal of the subscribe button.

in step 615, the alarm server detects whether the first client has an authority for subscribing to the alarm channel. After receiving the subscription request of the first client, the alarm server may detect whether the first client has the authority for subscribing to the alarm channel. The step of detecting whether the first client has the authority for subscribing to the alarm channel by the alarm server may include the following steps. First, an identity of the first client is sent to the authentication server to which the alarm channel corresponds. The alarm server may send the identity of the first client in the subscription request to the authentication server to which the alarm channel corresponds. For example, when the first client requests to subscribe to the alarm channel of Company A, the alarm server sends a job number of the first client in the subscription request to the authentication server to which the company A corresponds.

Second, the authentication server receives the identity of the first client sent from the alarm server. Third, the authentication server authenticates the identity of the first client. For example, after receiving the job number of the first client, the authentication server detects whether the job number is in the information database of the company. If the detection result indicates that the received job number is in the information database, the first client is authenticated by the authentication server. If the detection result indicates that the received job number is not in the information database, the first client is not authenticated by the authentication server. Additionally, when the authentication server creates two or more alarm channels at the same time, and each alarm channel corresponds to different groups of users, after receiving the job numbers, the authentication server may also detect whether the job numbers meet a predetermined condition, such as whether a job number is a job number of the manager-level staff. The present embodiment is not limited the above examples.

Fourth, when the first client is authenticated by the authentication server, an authentication confirmation message indicating a successful authentication is returned to the alarm server. When the first client is authenticated by the authentication server, which indicates that the first client has a subscription authority for subscribing to the alarm channel, the authentication server may return an authentication confirmation message indicating a successful authentication to the alarm server. The authentication confirmation message shows that the first client has the subscription authority for subscribing to the alarm channel. When the first client is not successfully authenticated by the authentication server, which indicates that the first client does not have a subscription authority for subscribing to the alarm channel, the authentication server may return a message indicating a failed authentication to the alarm server.

Fifth, the alarm server receives the authentication confirmation message indicating a successful authentication from the authentication server. Accordingly, the alarm. server may receive the authentication confirmation message indicating a successful authentication from the authentication server. If the alarm server receives a message indicating a failed authentication from the authentication server, the process ends.

In step 616, if the detection result of the alarm server indicates that the first client has the authority for subscribing to the alarm channel, the first client will be added to the subscription list, and an authentication confirmation message indicating a successful authentication is returned to the first client. If the detection result of the alarm server indicates that the first client has the authority for subscribing to the alarm channel, the alarm server may add the first client to the subscription list. Additionally, in order to inform the first client that it has successfully subscribed to the alarm channel, the alarm server may also send to the first client an authentication confirmation message indicating a successful subscription.

In step 617, the first client receives the authentication confirmation message indicating a successful subscription from the alarm server. Accordingly, the first client may receive the authentication confirmation message indicating a successful subscription from the alarm server, and after receiving the authentication confirmation message, the first client may learn that it has successfully subscribed to the alarm channel. Subsequently, the client may enjoy the event reminder service provided by the alarm channel.

Additionally, after subscribing to the alarm channel, the client may request to unsubscribe to the alarm channel. Referring to FIG. 6F, the method for event reminding further includes the following steps.

In step 618, a second client sends to the alarm server a cancellation request for unsubscribing to the alarm channel. When a user who has subscribed to the alarm channel no longer needs the alarm service, the user may send a cancellation request for unsubscribing to the alarm channel via his second client. For example, referring to FIG. 6G, the second client displays the alarm channel on a display interface. The user may click on the unsubscribe button on the display interface, and the second client sends the cancellation request for unsubscribing to the alarm channel after receiving the click signal.

In step 619, the alarm server receives the cancellation request for unsubscribing to the alarm channel sent from the second client. The alarm server may accordingly receive the cancellation request for unsubscribing to the alarm channel sent from the second client.

In step 620, the alarm server deletes the second client from the subscription list, and a cancellation confirmation message indicating a successful unsubscribing is returned to the second client. After the alarm channel receives the cancellation request for unsubscribing to the alarm channel, the alarm server may delete the second client from the subscription list, and the alarm server may also send a cancellation confirmation message indicating a successful unsubscribing to the second client.

In step 621, the second client receives the cancellation confirmation message indicating a successful unsubscribing from the alarm server.

The embodiments of the device in the present disclosure will be described as follows, and the embodiments that are not described in detail may be referred to the above corresponding embodiments.

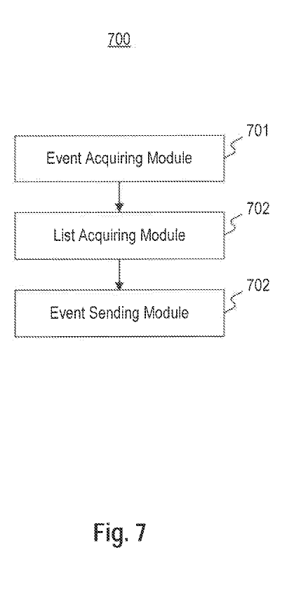

FIG. 7 is a block diagram of a device 700 for event reminding, according to an exemplary embodiment. Referring to FIG. 7, the device 700 for event reminding is utilized in the alarm server 120 of the system 100 (FIG. 1). The device 700 for event reminding may include, but not limited to, an event acquiring module 701, a list acquiring module 702, and an event sending module 703.

The event acquiring module 701 is configured to acquire is reminder event in an alarm channel. The alarm channel provides an event reminder service to a plurality of clients at the same time. The list acquiring module 702 is configured to acquire a subscription list of the alarm channel. The subscription list includes clients subscribing to the alarm channel. The event sending module 703 is configured to send the reminder event, acquired by the event acquiring module 701, to each client on the subscription list, acquired by the list acquiring module 702. The reminder event instructs each client to issue an event reminder according to the reminder event.

In summary, according to the above exemplary embodiment of the device 700 for event reminding, the device 700 is configured to conduct the following steps: acquiring a reminder event in an alarm channel, the alarm channel providing an event reminder service to a plurality of clients at the same time; acquiring a subscription list of the alarm channel, the subscription list including respective clients subscribing to the alarm channel; and sending the reminder event to each client on the subscription list, the reminder event instructing each client to issue an event reminder according to the reminder event without having a user to set an reminder/alarm in his terminal. The device 700 for event reminding, according to the above exemplary embodiment solves the problems in the related art that requires a user to set an alarm fix individual events. It also avoids the problem of a user forgetting to set an alarm and missing the important events. Additionally, the device 700 solves the problem of having an event notification issued too late for a user to set an event reminder. Accordingly, a user does not need to manually set an alarm, and can receive the alarm reminder timely. Thus, the user avoids delaying or forgetting an event.

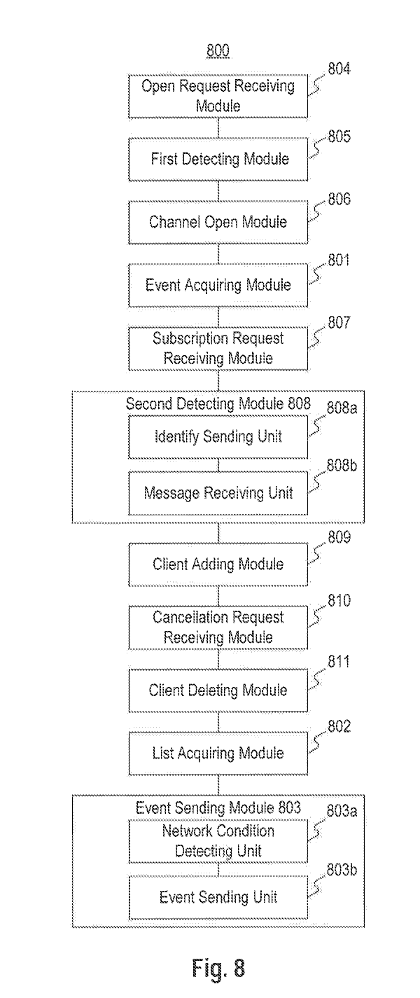

FIG. 8 is a block diagram of a device 800 for event reminding, according to an exemplary embodiment. Referring to FIG. 8, the device 800 for event reminding is utilized in the alarm server 120 of the system 100 (FIG. 1). The device 800 for event reminding may include, but not limited to, an event acquiring module 801, a list acquiring module 802, and an event sending module 803.

The event acquiring module 801 is configured to acquire a reminder event in an alarm channel. The list acquiring module 802 is configured to acquire a subscription list of the alarm channel. The event sending module 803 is configured to send the reminder event, acquired by the event acquiring module 801, to each client on the subscription list acquired by the list acquiring module 802.

In a first implementation of the exemplary embodiment, the event sending module 803 is configured to send to each of the clients the reminder event including the reminder time and the reminder reason.

In a second implementation of the exemplary embodiment, the event sending module 803 includes a network condition detecting unit 803a configured to detect whether a condition of a network in communication with the client is better than a preset condition. The event sending module 803 also includes an event sending unit 803b configured to send to the client the reminder event, if the condition of the network detected by the network condition detecting unit 803a is better than the preset condition. The reminder event includes the reminder time, reminder reason, and reminder manner, wherein the reminder manner includes at least one of a reminder number, a reminder ringtone, and a reminder page.

In a third implementation of the exemplary embodiment, the reminder ringtone includes a ringtone corresponding to the reminder event, and/or the reminder page, which includes an operating portal for guiding the clients to respond to the reminder event.

In a fourth implementation of the exemplary embodiment, the device 800 further includes: an open request receiving module 804 configured to receive an open channel request for opening an alarm channel sent from the authentication server; a first detecting module 805 configured to detect whether the authentication server has an authority to open the alarm channel; and a channel open module 806 configured to open the alarm channel if the detection result of the first detecting module 805 indicates that the authentication server has an authority to open the alarm channel, and return an open confirmation message to the authentication server indicating that the alarm channel has been opened successfully.

In a fifth implementation of the exemplary embodiment, the device further includes: a subscription request receiving module 807 configured to receive the subscription request sent from the first client for subscribing to the alarm channel; a second detecting module 808 configured to detect whether the first client has an authority to subscribe to the alarm channel; and a client adding module 809 configured to add the first client to the subscription list if the second detecting module 808 determines that the first client has the authority to subscribe to the alarm channel, and return a subscription confirmation message to the first client indicating a successful subscription.

In a sixth implementation of the exemplary embodiment, the second detecting module 808 includes: an identify sending unit 808a configured to send an identify of the first client to the authentication server to which the alarm channel corresponds; and a message receiving unit 808b configured to receive an authentication confirmation message, returned from the authentication server, indicating a successful authentication. The authentication confirmation message indicating a successful authentication is, returned from the authentication server, after the authentication server authenticates the first client according to the identity of the first client, and the authentication confirmation message indicates that the first client has the authority for subscribing to the alarm channel.

In a seventh implementation of this embodiment, the device 800 further includes: a cancellation request receiving module 810 configured to receive a cancellation request sent from the second client for unsubscribing to the alarm channel; and a client deleting module 811 configured to delete the second client from the subscription list, and return to the second client a cancellation confirmation message indicating a successful cancellation of the subscription.

In summary, according to the above exemplary embodiment of device 800, the device 800 is confirmed to conduct the following steps: acquiring a reminder event in an alarm channel, the alarm channel providing an event reminder service to a plurality of clients at the same time; acquiring a subscription list of the alarm channel, the subscription list including clients subscribing to the alarm channel; and sending the reminder event to each client on the subscription list, the reminder event instructing each client to issue an event reminder according to the reminder event without having a user to set an reminder/alarm in his terminal. The device 800 for event reminding, according to the above exemplary embodiment solves the problems in the related art that requires a user to set an alarm for individual events. It also avoids the problem of a user forgetting to set an alarm and missing the important events. Additionally, the device 800 solves the problem of having an event notification issued too late for a user to set an event reminder. Accordingly, a user does not need to manually set an alarm, and can receive the alarm reminder timely. Thus, the user avoids delaying or forgetting an event.

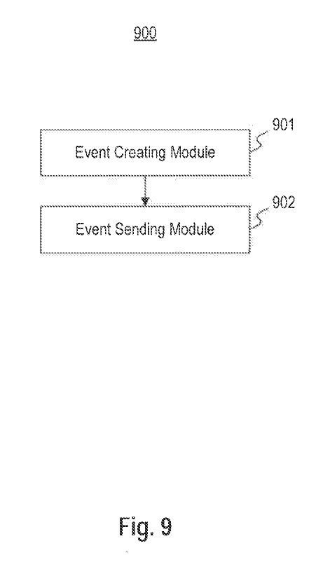

FIG. 9 is a block diagram of a device 900 for event reminding, according to an exemplary embodiment. Referring to FIG. 9, the device 900 for event reminding is utilized in the authentication server 110 in the system 100 (FIG. 1). The device 900 for event reminding may include, but not limited to, an event creating module 901 and an event sending module 902.

The event creating module 901 is configured to create a reminder event in an alarm channel, which provides an event reminder service to a plurality of clients at the same time. The event sending module 902 is configured to send the reminder event created by the event creating module 901 to an alarm server. The reminder event instructs the alarm server to forward the reminder event to each of the clients on a subscription list of the alarm channel, wherein the subscription list includes the clients subscribing to the alarm channel, and the reminder event instructs each client to issue an event reminder.

In summary, according to the above exemplary embodiment of the device 900, the device 900 is configured to conduct the following steps: creating a reminder event in an alarm channel, the alarm channel providing an event reminder service to a plurality of clients at the same time; and sending the reminder event to an alarm server, the reminder event instructing the alarm server to forward the reminder event to each client on the subscription list of the alarm channel, the subscription list including clients subscribing to the alarm channel, and the reminder event instructing each client to issue an event reminder. The device 900 for event reminding, according to the above exemplary embodiment solves the problems in the related art that requires a user to set an alarm for individual events, it also avoids the problem of a user forgetting to set an alarm and missing the important events. Additionally, the device 900 solves the problem of having an event notification issued too late for a user to set an event reminder. Accordingly, a user does not need to manually set an alarm, and can receive the alarm reminder timely. Thus, the user avoids delaying or forgetting an event.

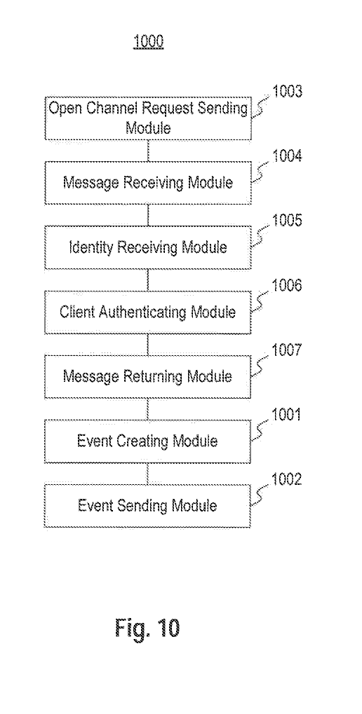

FIG. 10 is a block diagram of a device 1000 for event reminding, according to an exemplary embodiment. Referring to FIG. 10, the device 1000 for event reminding is utilized in the authentication server 110 in the system 100 (FIG. 1). The device 1000 for event reminding may include, but not limited to, an event creating module 1001 and an event sending module 1002. The event creating module 1001 is configured to create a reminder event in an alarm channel. The event sending module 1002 is configured to send the reminder event created by the event creating module 1001 to an alarm server, the reminder event indicating the alarm server to forward the reminder event to each client on a subscription list of the alarm channel.

In a first implementation of this embodiment, the event creating module 1001 is configured to create the reminder event including a reminder time, a reminder reason, and a reminder manner in the alarm channel, wherein the reminder manner includes at least one of a reminder number, a reminder ringtone, and a reminder page.

In a second implementation of this embodiment, the reminder ringtone includes a ringtone corresponding to the reminder event, and/or the reminder page, which includes an operating portal for guiding the client to respond to the reminder event.

In the second implementation of this embodiment, the device 1000 further includes: an open channel request sending module 1003 configured to send to the alarm server a request for opening the alarm channel; and a message receiving module 1004 configured to receive from the alarm server an open confirmation message indicating that an alarm channel has been successfully opened. The open confirmation message is returned from the alarm server after the alarm server receives the open channel request for opening the alarm channel, determines that the authentication server has the authority to open the alarm channel, and opens the alarm channel.

In a fourth implementation of this embodiment, the device 1000 further includes: an identity receiving module 1005 configured to receive from the alarm server an identity of a first client, the first client being a client requesting to subscribe to the alarm channel; a client authenticating module 1006 configured to authenticate the identity of the first client received by the identity receiving module 1005; a message returning module 1007 configured to return an authentication confirmation message indicating a successful authentication to the alarm server when the first client is successfully authenticated by the client authenticating module 1006. The authentication confirmation message returned by the message returning module 1007 also indicates that the first client has the authority for subscribing to the alarm channel.

In summary, according to the above exemplary embodiment of the device 1000, the device 1000 is configured to conduct the follow steps: creating a reminder event in an alarm channel, the alarm channel providing an event reminder service to a plurality of clients at the same time; and sending the reminder event to an alarm server, the reminder event instructing the alarm server to forward the reminder event to each client on the subscription list of the alarm channel, the subscription list including clients subscribing to the alarm channel, and the reminder event instructing each client to issue an event reminder. The device 1000 for event reminding, according to the above exemplary embodiment solves the problems in the related art that requires a user to set an alarm for individual events. It also avoids the problem of a user forgetting to set an alarm and missing the important events. Additionally, the device 1000 solves the problem of having an event notification issued too late for a user to set an event reminder. Accordingly, a user does not need to manually set an alarm, and can receive the alarm reminder timely. Thus, the user avoids delaying or forgetting an event.

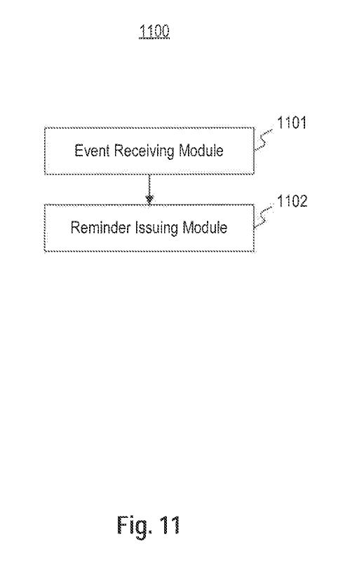

FIG. 11 is a block diagram of a device 1100 for event reminding, according to an exemplary embodiment. Referring to FIG. 11, the device 1100 for event reminding is utilized in the client 130 of the system 100 (FIG. 1). The device 1100 for event reminding may include, but not limited to an event receiving module 1101 and a reminder issuing module 1102.

The event receiving module 1101 is configured to receive a reminder event sent from an alarm server. The reminder event is in an alarm channel, and is acquired by the alarm server. Additionally, the reminder event is sent to each client on an acquired subscription list of the alarm channel, which provides an event reminder service to a plurality of clients at the same time, whereon the subscription list includes clients subscribing to the alarm channel.

The reminder issuing module 1102 is configured to issue an event reminder according to the reminder event.

In summary, according to the device 1100 for event reminding provided in the above exemplary embodiment, by receiving a reminder event sent from an alarm server, the alarm channel providing an event reminder service to a plurality of clients at the same time, and then the client issues an event reminder according to the reminder event, wherein the reminder event is in an alarm channel, acquired by the alarm server, and sent to each client in an acquired subscription list of the alarm channel; and wherein, the subscription list includes clients subscribing to the alarm channel. The device 1100 for event reminding in the above exemplary embodiment solves the problems in the related art requiring a user to set an alarm for individual events. It also avoids the problem of forgetting to set an alarm and missing the important events, or the problem of having an event notification issued too late for a user to set an event reminder. According to the device 1100 for event reminding in the above exemplary embodiment, a user does not need to manually set an alarm, and can receive the alarm reminder timely. Thus, the user avoids delaying or forgetting an event.

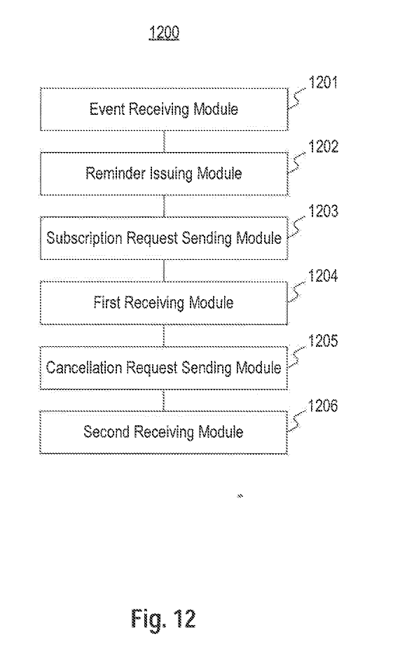

FIG. 12 is a block diagram of a device 1200 for event reminding, according to an exemplary embodiment. Referring to FIG. 12, the device 1200 for event reminding is utilized in the client 130 of the system 100 (FIG. 1). The device 1200 for event reminding may include, but not limited to, an event receiving module 1201 and a reminder issuing module 1202.

The event receiving module 1201 is configured to receive a reminder event sent from an alarm server. The reminder event is in an alarm channel, and is acquired by the alarm server. Additionally, the reminder event is sent to each client on an acquired subscription list of the alarm channel, wherein the subscription list includes clients subscribing to the alarm channel. Additionally, the alarm channel provides an event reminder service to a plurality of clients at the same time.

The reminder issuing module 1202 is configured to issue an event reminder according to the reminder event.

In a first implementation of the present embodiment, the device 1200 further includes: a subscription request sending module 1203 configured to send to the alarm server a channel subscription request for subscribing to the alarm channel; and a first receiving module 1204 configured to receive a subscription confirmation message, returned from the alarm server, indicating a successful subscription.

In a second implementation of the present embodiment, the device 1200 further includes: a cancellation request sending module 1205 configured to send a cancellation request to the alarm server liar unsubscribing to the alarm channel; and a second receiving module 1206 configured to receive from the alarm server a cancellation confirmation message indicating a successful cancellation.

In summary, according to the above exemplary embodiment of device 1200 for event reminding, the device 1200 is configured to conduct the fallowing steps: receiving a reminder event sent from an alarm server, the reminder event being in an alarm channel, acquired by the alarm server, and, sent to each client in a subscription list of the alarm channel after acquiring the subscription list, the alarm channel providing an event reminder service to a plurality of clients at the same time, and the subscription list including the clients subscribing to the alarm channel. The device 1200 for event reminding in the above exemplary embodiment solves the problems in the related art requiring a user to set an alarm for individual events. It also avoids the problem of forgetting to set an alarm and missing the important events, or the problem of having an event notification issued too late for a user to set an event reminder. According to the device 1200 for event reminding in the above exemplary embodiment, a user does not need to manually set an alarm, and can receive the alarm reminder timely. Thus, the user avoids delaying or forgetting an event.

The present invention additionally provides a system for event reminding which may include an alarm server, an authentication server, and a client. Details of the alarm server correspond to the exemplary embodiments discussed in the context of FIG. 7 or FIG. 8. Details of the authentication server corresponds to the exemplary embodiments discussed in the context of FIG. 9 or FIG. 10. Details of the client correspond to the exemplary embodiments discussed in the context of FIG. 11 or FIG. 12. Details of the embodiments of the system for event reminding are not repeated here.

In summary, according to the system for event reminding in the present embodiment, by conducting the following steps of acquiring a reminder event in an alarm channel; acquiring a subscription list of the alarm channel; and sending the reminder event to each client on the subscription list without requiring a user to set a reminder/alarm in his terminal. The system for event reminding in the above exemplary embodiment solves the problems in the related art requiring a user to set an alarm for individual events. It also avoids the problem of forgetting to set an alarm and missing the important events, or the problem of having an event notification issued too late for a user to set an event reminder. According to the system for event reminding in the above exemplary embodiment, a user does not need to manually set an alarm, and can receive the alarm reminder timely. Thus, the user avoids delaying or forgetting an event.

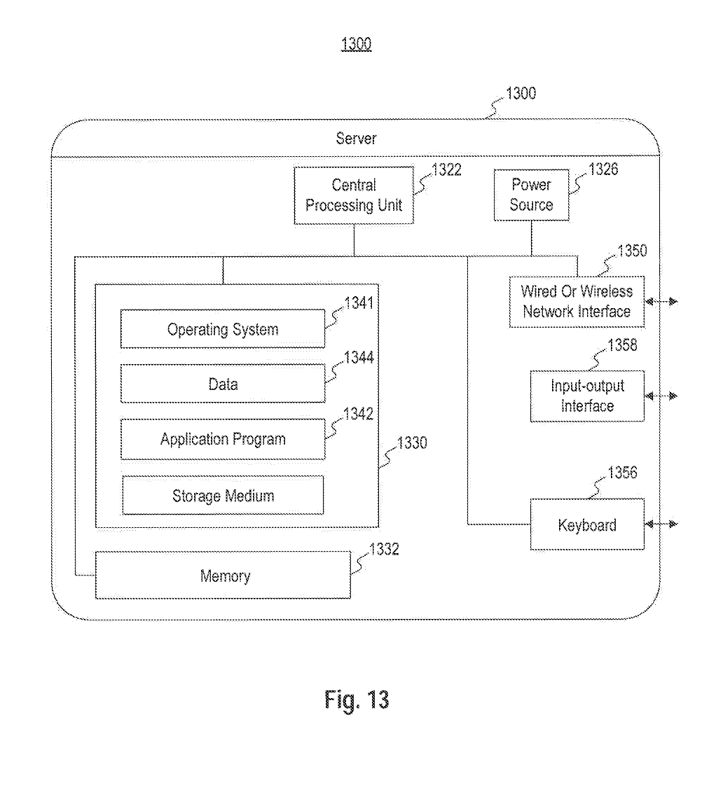

FIG. 13 is a block diagram of a server 1300 according to an exemplary embodiment. Referring to FIG. 13, the server 1300 may be the authentication server 110 or the alarm server 120 of the system 100 (FIG. 1). Additionally, the server 1300 may have difference configurations. The server 1300 may include one or more central processing units (CPUs) 1322, memory 1332, and storage medium 1330 for storing application programs 1342 or data 1344. The memory 1332 and the storage medium 1330 may be a short-term or long-term storage. The program stored in the storage medium 1330 may include one or more modules (not shown in the drawings), and each module may include a series of operation commends for the server 1300. Further, the CPU 1322 may be configured to communicate with the storage medium 1330, and execute a series of operation commends in the storage medium 1330 on the server 1300.

The server 1300 may also include one or more power sources 1326, one or more wired or wireless network interfaces 1350, one or more input-output interfaces 1358, one or more keyboards 1356, and/or one or more operating systems 1341, such as Windows Server™, Mac OS X™, Unix™, Linux™, and FreeBSD™.

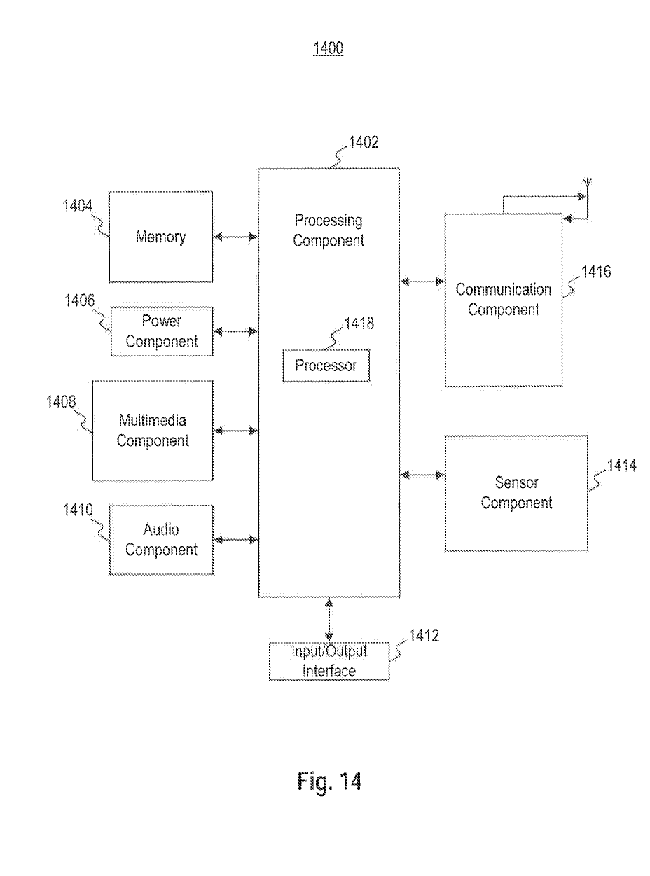

FIG. 14 is a block diagram of a device 1400, according to an exemplary embodiment. For example, the device 1400 may be a mobile phone, a computer, a digital broadcast terminal, a messaging device, a game console, a tablet device, or a personal digital assistants.

Referring to FIG. 14, the device 1400 may include one or more of the following components: a processing component 1402, a memory 1404, a power component 1406, a multimedia component 1408, an audio component 1410, an input/output (I/O) interface 1412, a sensor component 1414, and a communication component 1416.

The processing component 1402 controls overall operations of the device 1400, such as the operations associated with display, telephone calls, data communications, camera operations, and recording operations. The processing component 1402 may include one or more processors 1420 to execute instructions to perform all or part of the steps in the above described methods. Moreover, the processing component 1402 may include one or more modules which facilitate the interaction between the processing component 1402 and other components. For instance, the processing component 1402 may include a multimedia module to facilitate the interaction between the multimedia component 1408 and the processing component 1402.

The memory 1404 is configured to store various types of data to support the operation of the device 1400. Examples of such data include instructions for any applications or methods operating on the device 1400, such as contact data, phonebook data, messages, pictures, video, etc. The memory 1404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic, or an optical disk.

The power component 1406 provides power to various components of the device 1400. The power component 1406 may include a power management system, one or more power sources, and any other components associated with the generation, management, and distribution of power in the device 1400.

The multimedia component 1408 includes a screen providing an output interface between the device 1400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may sense a boundary of a touch or swipe action, and may also sense a time period and a pressure associated with the touch or swipe action. In some embodiments, the multimedia component 1408 includes a front camera and/or a rear camera. The front camera and/or the rear camera may receive an external multimedia data while the device 1400 is in an operation mode, such as a photographing mode or a video recording mode. Each of the front camera and the rear camera may have fixed optical lens system or have focus and optical zoom capability.

The audio component 1410 is configured to output and/or input audio signals. For example, the audio component 1410 includes a microphone (“MIC”) configured to receive an external audio signal when the device 1400 is in an operation mode, such as a call mode, a recording mode, and a voice recognition mode. The received audio signal may be stored in the memory 1404 or transmitted via the communication component 1416. In some embodiments, the audio component 1410 further includes a speaker to output audio signals.

The I/O interface 1412 provides an interface between the processing component 1402 and peripheral interface modules, such as a keyboard, a click wheel, buttons, and the like. The buttons may include, but not limited to, a home button, a volume button, a starting button, and a locking button.

The sensor component 1414 includes one or more sensors to provide status assessments of various aspects of the device 1400. For instance, the sensor component 1414 may detect an open/closed status of the device 1400, relative position of components, e.g., the display and the keypad, of the device 1400, a change in position of the device 1400 or a component of the device 1400, a presence or absence of user contact with the device 1400, an orientation or an acceleration/deceleration of the device 1400, and a change in temperature of the device 1400. The sensor component 1414 may include a proximity sensor configured to detect the presence of nearby objects without any physical contact. The sensor component 1414 may also include a light sensor, such as a CMOS or CCD image sensor, for use in imaging applications. In some embodiments the sensor component 1414 may also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G, or 3G, or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404, executable by the processor 1418 in the device 1400, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes ma be made without departing from the scope thereof. It is intended that the scope of the invention only be limited by the appended claims.

What is claimed is:

1. A method for event reminding, comprising:
acquiring a reminder event in an alarm channel, the alarm channel providing an event reminder service to a plurality of clients at the same time;
acquiring a subscription list of the alarm channel, the subscription list comprising the clients subscribing to the alarm channel; and
sending the reminder event to the clients on the subscription list, the reminder event instructing each of the clients to issue an event reminder according to the reminder event.

2. The method according to claim 1, wherein the reminder event comprises:
a reminder time, and a reminder reason.

3. The method according to claim 1, wherein the sending of the reminder event comprises:
detecting whether a condition of a network in communication with the clients is better than a preset condition; and
if the condition of the network in communication with the clients being better than the preset condition, sending the reminder event to the clients, the reminder event including a reminder time, a reminder reason, and a reminder manner, wherein the reminder manner includes at least one of a reminder number, a reminder ringtone, and a reminder page.

4. The method according to claim 3, wherein
the reminder pate comprises an operating portal for guiding the clients to respond to the reminder event.

5. The method according to claim 1, further comprising:
receiving from an authentication server an open channel request for opening the alarm channel;
detecting whether the authentication server has an authority to open the alarm channel; and
if the authentication server has the authority to open the alarm channel, opening the alarm channel, and returning an open confirmation message to the authentication server indicating the opening of the alarm channel.

6. The method according to claim 1, wherein the plurality of clients include a first client, the method further comprising:
receiving a channel subscription request from a first client for subscribing to the alarm channel;
detecting whether the first client has an authority to subscribe to the alarm channel; and
if the first client has the authority to subscribe to the alarm channel, adding the first client to the subscription list; and returning a subscription confirmation message to the first client.

7. The method of claim 6, wherein the detecting of whether the first client has the authority to subscribe to the alarm channel comprises:
sending an identify of the first client to an authentication server to which the alarm channel corresponds; and
receiving an authentication confirmation message from the authentication server after authenticating the identity of the first client, the authentication confirmation message indicating that the first client having a subscription authority for subscribing to the alarm channel.

8. The method according to claim 1, wherein the plurality of clients include a first client, the method further comprising:
receiving from the first client a cancellation request for unsubscribing to the alarm channel; and
deleting the first client from the subscription list; and
returning a cancellation confirmation message to the first client.

9. A method for event reminding, comprising:
creating a reminder event in an alarm channel, the alarm channel providing an event reminder service to a plurality of clients at the same time; and
sending the reminder event to an alarm server, the reminder event instructing the alarm server to forward the reminder event to the clients on a subscription list of the alarm channel, the subscription list comprising the clients subscribing to the alarm channel, and the reminder event instructing each of the clients to issue an event reminder according to the reminder event.

10. The method according to claim 9, wherein the reminder event comprises:
a reminder time, a reminder reason, and a reminder manner, the reminder manner comprising at least one of a reminder number, a reminder ringtone, and a reminder page.

11. The method according to claim 10, wherein
the reminder pan comprises an operating portal for guiding the clients to respond to the reminder event.

12. The method according to claim 9, further comprising:
sending to the alarm server an open channel request for opening the alarm channel; and
receiving an open confirmation message from the alarm server, the open confirmation message being returned after the alarm server:
receiving the open channel request,
detecting the authentication server having an authority to open the alarm channel, and
opening the alarm channel.

13. The method according to claim 9, wherein the plurality of clients include a first client, the method further comprising:
receiving an identity of the first client from the alarm server, the first client requesting to subscribe to the alarm channel;
authenticating the identity of the first client; and
if the identity of the first client is authenticated, returning an authentication confirmation message to the alarm server, the authentication confirmation message indicating the first client having a subscription authority for subscribing to the alarm channel.

14. A method for event reminding, comprising:
receiving a reminder event from an alarm server, the reminder event being acquired from an alarm channel by the alarm server, and being sent to each of a plurality of clients on a subscription list of the alarm channel after acquiring the subscription list, the alarm channel providing an event reminder service to the clients at the same time, and the subscription list comprising the clients subscribing to the alarm channel; and
issuing an event reminder according to the reminder event.

15. The method according to claim 14, further comprising:
sending to the alarm server a subscription request for subscribing to the alarm channel; and
receiving a subscription confirmation message from the alarm server.

16. The method according to claim 14, further comprising:
sending to the alarm server a cancellation request for unsubscribing to the alarm channel; and
receiving a cancellation confirmation message from the alarm server.

17. A terminal for event reminding, comprising:
a processor; and
a memory for instructions executable by the processor;
wherein the processor is configured to:
receive a reminder event from an alarm server, the reminder event being acquired from an alarm channel by the alarm server, and being sent to each of a plurality of clients on a subscription list of the alarm channel after acquiring the subscription list, the alarm channel providing an event reminder service to the clients at the same time, and the subscription list comprising the clients subscribing to the alarm channel; and
issue an event reminder according to the reminder event.

18. The terminal according to claim 17, wherein the processor is further configured to:
send to the alarm server a subscription request for subscribing to the alarm channel; and
receive a subscription confirmation message from the alarm server.

19. The terminal according to claim 17, wherein the processor is further configured to:
send to the alarm server a cancellation request for unsubscribing to the alarm channel; and
receive a cancellation confirmation message from the alarm server.
